(19) United States
(12) Patent Application Publication
(10) Pub. No.: US 2014/0128129 A1
(43) Pub. Date: May 8, 2014

(54) Method and Apparatus for Passing Voice Between a Mobile Device and a Vehicle

(71) Applicant: Ford Global Technologies, LLC, Dearborn, MI (US)

(72) Inventors: Doron M. Elliott, Detroit, MI (US); Yiping Xia, Shanghai (CN)

(73) Assignee: Ford Global Technologies, LLC, Dearborn, MI (US)

(21) Appl. No.: 13/672,121

(22) Filed: Nov. 8, 2012

(51) Int. Cl. H04W 88/02

(52) U.S. Cl. CPC H04W 88/02
USPC 455/569.2

(57) ABSTRACT

A system includes a processor configured to receive a request to activate a voice input responsive function on a mobile device. The processor is further configured to send indicia of an incoming call to a vehicle computing system (VCS), responsive to the request. Also, the processor is configured to receive access to an open voice channel originating at the VCS as part of a VCS hands-free call handling for a virtual phone call established by sending the indicia and receive voice input over the hands-free call channel. The processor is additionally configured to pass the voice input to the voice input responsive function. The processor is also configured to receive output from the voice input responsive function and pass the output to the VCS for output to the user.

### TECHNICAL FIELD

The illustrative embodiments generally relate to a method and apparatus for passing voice communication between a mobile device and a vehicle.

### BACKGROUND

Many cellular phones now come with “AI” installed thereon, which can resemble a combination of speech searching functionality and intelligent response. Users can use these phones to instruct a voice command, and the AI will process the command and produce a presumably desired result.

In some instances, however, use of these commands can be distracting, as when a user attempts to enter such a command while driving. Accordingly, it might be a better solution for a driver if the search command could be entered through a vehicle system. Since the vehicle system may not be equipped to handle the AI in the manner of the phone, there may be an additional step of passing the input command to a phone. Unfortunately, due to the difficulties of passing audio from a vehicle computing system to a phone (largely due to the varied nature of phone operating systems and interfaces), simply passing the audio directly to the phone may not always be an option.

U.S. Pat. No. 7,801,283 generally discusses a hands-free, Bluetooth enabled telephone system for a vehicle is configured to enable an operator such as the driver of the vehicle to say multiple voice commands at one time in order to control the operation of the telephone system. Such multiple commands include “Dial <name>”, “Dial <name location>”, “Dial <number>”, and “Send <account number>.” The hands-free, Bluetooth enabled telephone system enables the pairing between Bluetooth enabled cell phones and a Bluetooth communications module of the telephone system to be conducted in a human friendly manner. The hands-free, Bluetooth enabled telephone system enables the telephone system to generate DTMF tones corresponding to a numeric account number or password in response to the driver vocally saying an account name associated with the numeric account number or password during a call between the driver and a voice-automated, menu-driven system for receipt by the menu-driven system.

In another instance, U.S. Pat. No. 6,845,251 generally relates to a method for controlling a phone system having speech recognition capabilities. The method includes entering a phone number into a phone system using a first voice command, dialing the phone number using a second voice command, associating the phone number with a tag using a third voice command, and storing the tag into the phone directory using a fourth voice command. The phone system of the present invention repeats the voice commands after the system receives each of the commands from a user.

### SUMMARY

In a first illustrative embodiment, a system includes a processor configured to receive a request to activate a voice input responsive function on a mobile device. The processor is further configured to send indicia of an incoming call to a vehicle computing system (VCS), responsive to the request. Also, the processor is configured to receive access to an open voice channel originating at the VCS as part of a VCS hands-free call handling for a virtual phone call established by sending the indicia and receive voice input over the hands-free call channel. The processor is additionally configured to pass the voice input to the voice input responsive function. The processor is also configured to receive output from the voice input responsive function and pass the output to the VCS for output to the user.

In a second illustrative embodiment, a system includes a mobile phone processor configured to receive a request to activate a function utilizing voice input. The processor is also configured to send indicia of an incoming call to a connected vehicle computing system (VCS) to establish a virtual call, responsive to the request. Also, the processor is configured to receive voice data over a call channel from the VCS as though a call were in progress. The processor is further configured to pass the received voice data from the call channel to the function utilizing voice input.

In a third illustrative embodiment, a computer implemented method includes receiving a request to activate a function utilizing voice input. The method also includes sending indicia of an incoming call to a connected vehicle computing system (VCS) to establish a virtual call, responsive to the request. The method further includes receiving voice data over a call channel from the VCS as though a call were in progress. Further, the method includes passing the received voice data from the call channel to the function utilizing voice input.

### BRIEF DESCRIPTION OF THE DRAWINGS

FIG. 1 shows an illustrative example of a vehicle computing system;

FIG. 2 shows an illustrative example of an arbitration application communicating with a vehicle computing system; and

FIG. 3 shows an illustrative example of a searching process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

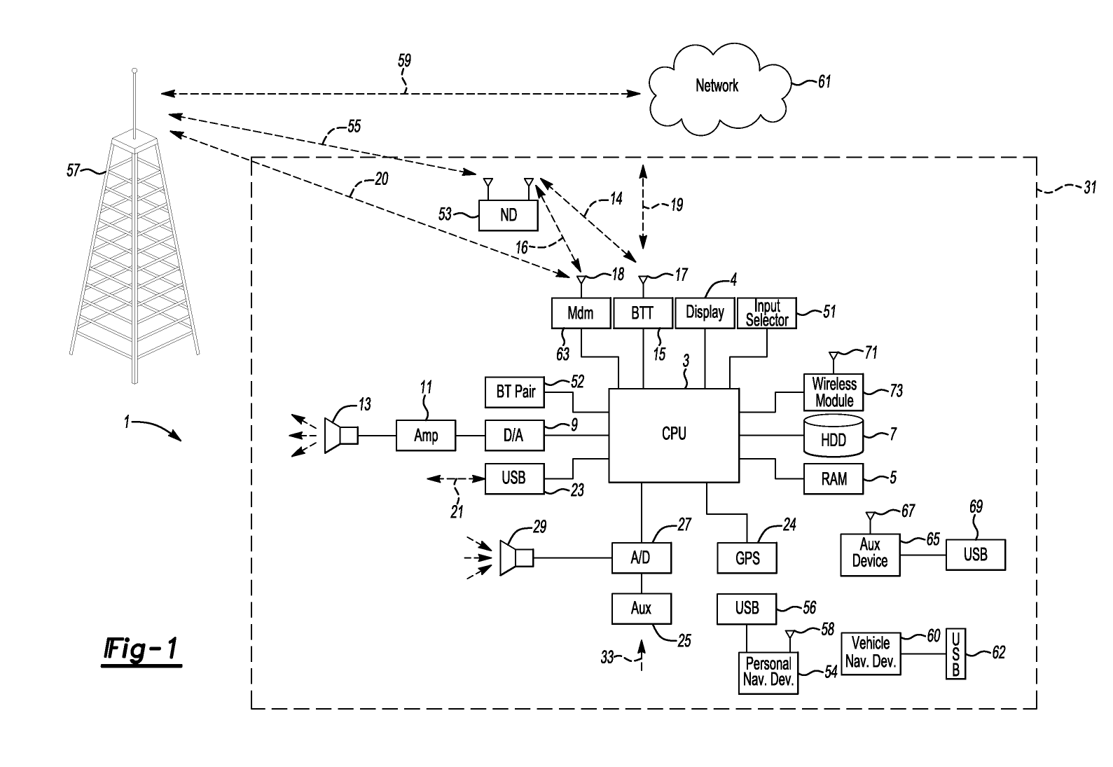

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS).

In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Mobile devices are coming equipped with increasing voice-recognition and responsive functionality. Many of these applications send the data off-board to the cloud, where the data is processed and a response is received. In order to utilize an application in a vehicle connected solution (e.g., where a mobile device is desired to be accessed through a wireless connection with a vehicle computing system), a solution for passing audio from the VCS to the mobile device must be established.

Accordingly, a system is proposed that utilizes capability provided to every mobile phone, namely, the ability to pass voice communication via a virtual phone call. Because of the nature of communication between a mobile device and a vehicle computing system, in the illustrative embodiments, instead of calling another device, the mobile phone can actually be used to make a virtual call to itself.

Once the mobile phone has been paired with a vehicle computing system, calls coming into the mobile phone will be answered by the vehicle computing system. As such, it is possible to “fake” a phone call between a connected device and the vehicle computing system. The phone, through a process running thereon, can send indica of an incoming phone call, along with the appropriate variables. This can cause the vehicle computing system to “answer” the call and open an appropriate audio channel (e.g., synchronus connection-oriented link (SCO)). The user can then speak to the vehicle through a vehicle input (e.g., microphone) and the verbal input will be passed, via the voice channel for the call, to the mobile device. An example of one method of performing this transfer is shown with respect to FIG. 3.

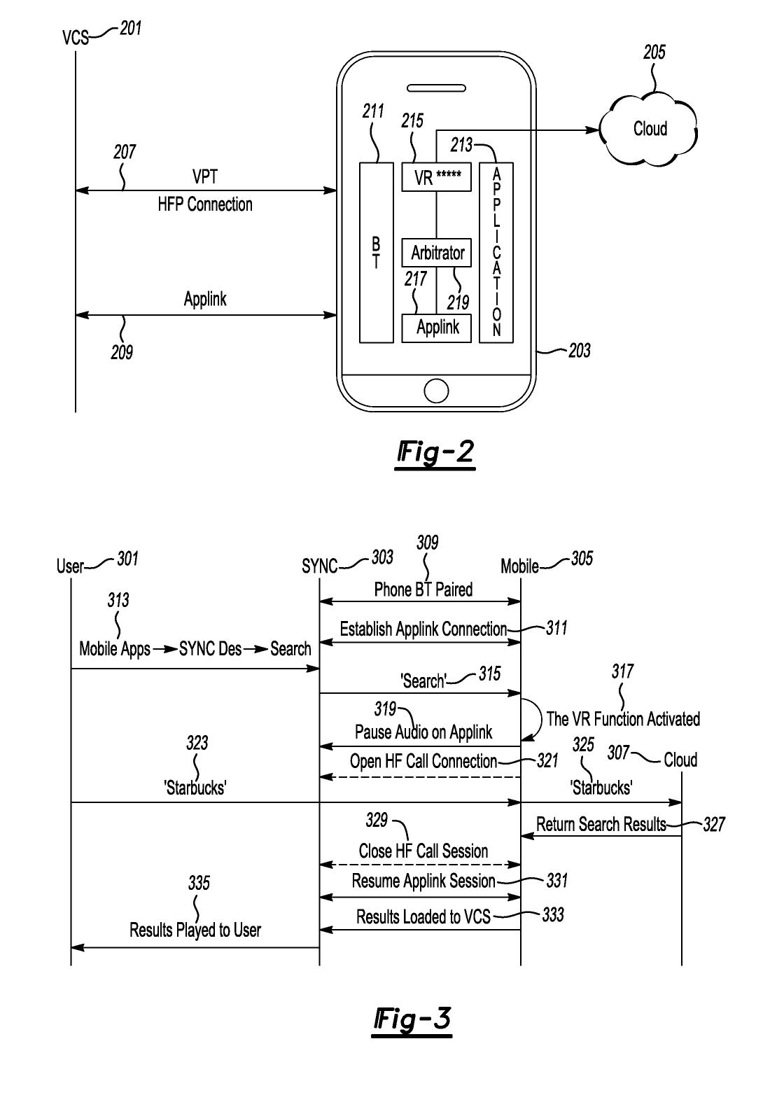

FIG. 2 shows an illustrative example of an arbitration application communicating with a vehicle computing system. In this illustrative embodiment, a mobile device is in communication, on one level, with a vehicle computing system over Bluetooth 211. Communication over Bluetooth allows control of mobile applications using a vehicle computing system.

In this embodiment, an API called Applink 209 is used to communicate over Bluetooth with a mobile device, in order to take advantage of enabled applications on the mobile device. The Applink API allows the vehicle computing system to communicate with the mobile device, through similarly provided library 219. Utilizing Applink commands, the driver or other user can activate and interact with certain applications 213 running or runnable on the mobile device.

Applink, in this instance, is also in communication with an arbitration application 219. The arbitration application provides for communication between the incoming audio over the open call communication channel (established by the virtual call) and any application that might need input from the device. A function called the VR function can pass the data to the cloud for processing as the user speaks the data during the call. The arbitration application can received incoming verbal data over the mobile voice communication channel and format/pass this data to Applink and/or to specific applications 213, 215 as needed by the applications. The arbitration application can also be used, as needed, to activate/deactivate the mobile phone calls.

For example, without limitation, a mobile device may be enabled with a “Search” function. If the user were merely using the mobile device, the user may select “search” and then be prompted to input a search string. Once the string had been received, the device may perform the appropriate search, and either visually or verbally (or both) output the results. Often, these services use cloud-based voice recognition technology.

In the model shown, the user may be driving down the road and wish to use the search function. In this case, the user may speak to the vehicle system “search,” and then, when prompted, “Novi Bowl Bowling Alley, Novi, Mich.” If this were input into the phone, the user wouldn't necessarily speak “search,” but would activate search and then speak “Novi Bowl Bowling Alley, Novi, Mich.” In some other instances, the user would speak the entire string, including “search” into the phone, if the phone were set up in such a manner as to recognize “search” as a reason to initiate a search command.

In the example system, speaking “search” can cause the arbitrator to recognize (possibly from an applink instruction) that a verbal input is needed for an upcoming application. Here, the command “search” may be passed as instructions to activate a search application from the VCS, as opposed to simply being passed as audio to the phone. In other instances, the application may be touch activated from the VCS, for example.

Responsive to launching an application that requires verbal input, the process could call on the arbitrator to open virtual phone call (with the VCS as an intermediary). Audio information then passed from a user to the VCS can be passed to the phone (over the call audio channel) and can be subsequently passed to the VR function for input into the cloud. When the VR function receives results, they can be passed to and stored by the arbitration application, which, once the virtual call session has been ended, can present them in an appropriate manner to the user via Applink.

FIG. 3 shows an illustrative example of a searching process. In this illustrative example, there are several entities involved in the processing of a search command. There is a user 301, which will typically be a vehicle occupant. There is also a VCS 303, which can communicate with a mobile device 305. Finally, in this example, there is also a cloud 307, wherein the voice search and recognition processing will be done.

In this example, the mobile device and the VCS are paired with each other over a Bluetooth connection 309. The Bluetooth connection allows the passing of a number of types of information, including, in this example, instructions packets over a process known as Applink 311. Once an Applink connection has been established, the vehicle computing system may receive one or more mobile applications activateable on the phone, which, in this example, includes a search function.

In this illustrative embodiment, the user utilizes some form of appropriate input at the vehicle to indicate that a search is desired 313. Resultant from this search request, a command “Search” is sent to the phone. Although a user may speak “search” to activate a search function, the actual verbal command “Search” may not be passed from the VCS to the phone, but could function as a trigger for an application. The VCS, however, through applink, may be able to instruct activation of the search command on the mobile device 315, by recognizing what it is that the user desires.

In response to the activation of the search application, the arbitrator may recognize that further verbal input is required. In this example, the input will come from an exterior source, namely, as a result of the virtual phone call. In this example, the mobile device pauses any audio requests through the applink connection 319 and opens a hands free call connection 321. The call is is a virtual call, acutally just comprising indicia of an incoming call. Essentially, the mobile device “fakes” a phone call, from itself, which is answered by the vehicle computing system 303.

Since the phone call is acutally spoofed, and all the indicia of an incoming call are passed to the VCS without making an actual call, the problem of a busy signal when the phone “calls itself” is avoided. Instead, the VCS believes that an incoming call is present (the mobile number being that of the phone itself) and it “answers” the call, providing audio between the VCS and the mobile device. This audio is then retasked to provide audio data to one or more applications.

Once the phone has established a connection with the vehicle computing system (and thereby establishing a voice-call audio connection with itself), input such as a search destination “starbucks” 323 may be made from the user to the VCS (which is handling the call). This audio is passed through the voice connection to the mobile device (over a cellular call channel, for example) and from there the VR function can send the verbal input to the cloud 325.

Search results 327 can then be returned from the cloud to the mobile device, at which time the virtual call can presumably be terminated (since the necessary audio for the search has been received). The hands-free call session is closed 329, and the arbitration process resumes the applink session 331 between the VCS and the mobile device, so that data can again be passed between the two entities over applink. Since the mobile device is also capable of saving the results of the search (via, for example, the arbitration application), the results can be formatted in a manner appropriate for passing over applink 333.

Once formatted (if needed), the results can then be passed over applink from the phone to the VCS, and then can be presented to the user in an appropriate format 335.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a request to activate a voice input responsive function on a mobile device;
responsive to the request, send indicia of an incoming call to a vehicle computing system (VCS);
receive access to an open voice channel originating at the VCS as part of a VCS hands-free call handling for a virtual phone call established by sending the indicia;
receive voice input over the hands-free call channel;
pass the voice input to the voice input responsive function;
receive output from the voice input responsive function; and
pass the output to the VCS for output to the user.

2. The system of claim 1, wherein the processor is further configured to terminate the virtual phone call following receipt of the output.

3. The system of claim 1, wherein the indicia of an incoming call includes a mobile number.

4. The system of claim 3, wherein the mobile number is the number of the mobile device sending the indicia.

5. The system of claim 1, wherein the processor is further operable to send the input passed to the voice input responsive function to a remote server for processing.

6. The system of claim 5, wherein the processor is further operable to receive output from the remote server.

7. The system of claim 6, wherein the output from the remote server is passed as the output from the voice input responsive function.

8. The system of claim 1, wherein the processor is in communication with the VCS over a BlueTooth connection.

9. A system comprising:
a mobile phone processor configured to:
receive a request to activate a function utilizing voice input;
responsive to the request, send indicia of an incoming call to a connected vehicle computing system (VCS) to establish a virtual call;
receive voice data over a call channel from the VCS as though a call were in progress; and
pass the received voice data from the call channel to the function utilizing voice input.

10. The system of claim 9, wherein the indicia includes a mobile phone number.

11. The system of claim 10, wherein the mobile phone number is the number of the mobile phone to which the processor is provided.

12. The system of claim 9, wherein the processor is further configured to execute an arbitration application to pass data between applications and handle output from the applications.

13. The system of claim 9, wherein the processor is further configured to communicate with the VCS over a BlueTooth connection.

14. The system of claim 13, wherein the call channel is a synchronous connection oriented link channel.

15. A computer implemented method comprising:
receiving a request to activate a function utilizing voice input;
responsive to the request, sending indicia of an incoming call to a connected vehicle computing system (VCS) to establish a virtual call;
receiving voice data over a call channel from the VCS as though a call were in progress; and
passing the received voice data from the call channel to the function utilizing voice input.

16. The method of claim 15, wherein the indicia includes a mobile phone number.

17. The method of claim 16, wherein the mobile phone number is the number of the mobile phone to which the processor is provided.

18. The method of claim 15, wherein the method further includes executing an arbitration application to pass data between applications and handle output from the applications.

19. The method of claim 15, wherein the method further includes communicating with the VCS over a BlueTooth connection.

20. The method of claim 19, wherein the call channel is a synchronous connection oriented link channel.
